(19) United States
(12) Patent Application Publication
(10) Pub. No.: US 2012/0050629 A1
(43) Pub. Date: Mar. 1, 2012

(54) LIQUID CRYSTAL DISPLAY FOR THREE-DIMENSIONAL ACTIVE SHUTTER GLASSES

(75) Inventors: Dong Seop LEE, Seoul (KR); Joon Gyu LEE, Ansan-si (KR)

(73) Assignee: SAMSUNG ELECTRONICS CO. LTD., Suwon-si (KR)

(21) Appl. No.: 13/214,642

(22) Filed: Aug. 22, 2011

(30) Foreign Application Priority Data
Aug. 24, 2010 (KR) 10-2010-0081731

(51) Int. Cl. G02F 1/1335

(52) U.S. Cl. 349/13

(57) ABSTRACT

A liquid crystal display for three-dimensional active shutter glasses is provided. The liquid crystal display includes an upper Indium Tin Oxide (ITO) electrode formed in a low surface of the upper glass and formed with a plurality of upper electrode patterns electrically connected to each other, and a lower ITO electrode formed in an upper surface of the lower glass and formed with a plurality of lower electrode patterns electrically connected to each other. Thereby, a liquid crystal operation characteristic is prevented from being deteriorated, a transmittance of incidence light is improved, and a user can view a brighter screen.

### PRIORITY

This application claims the benefit under 35 U.S.C. §119(a) of a Korean patent application filed on Aug. 24, 2010 in the Korean Intellectual Property Office and assigned Serial No. 10-2010-0081731, the entire disclosure of which is hereby incorporated by reference.

### BACKGROUND OF THE INVENTION

1. Field of the Invention

The present invention relates to a liquid crystal display for three-dimensional active shutter glasses. More particularly, the present invention relates to a liquid crystal display for three-dimensional active shutter glasses for sequentially blocking and passing through light of a three-dimensional image.

2. Description of the Related Art

Recently, in order to view a three-dimensional image, a demand for a three-dimensional display product such as a three-dimensional image television has greatly increased. A method of viewing a three-dimensional display is classified into a non-glasses method and a glasses method, and the glasses method is classified into a passive method and an active method. Polarizing glasses are used for the passive method, and three-dimensional active shutter glasses are used for the active method.

FIG. 1 is a perspective view illustrating three-dimensional active shutter glasses and a plan view illustrating a shape of an Indium Tin Oxide (ITO) electrode of a liquid crystal display for the three-dimensional active shutter glasses according to the related art. FIG. 2 is a cross-sectional view illustrating a liquid crystal display used for three-dimensional active shutter glasses according to the related art.

Referring to FIGS. 1 and 2, a conventional liquid crystal display 20 for three-dimensional active shutter glasses 10 is described.

The liquid crystal display 20 for three-dimensional active shutter glasses 10 includes a lower polarizing plate 21a, a lower glass 22a, a liquid crystal layer 24, an upper glass 22b, an upper polarizing plate 21b, and a pair of ITO electrodes 23a and 23b of a lower ITO electrode 23a formed on an upper surface of the lower glass 22a and an upper ITO electrode 23b formed on a lower surface of the upper glass 22b. The lower ITO electrode 23a and the upper ITO electrode 23b are formed over an entire active area.

In the liquid crystal display 20 of the three-dimensional active shutter glasses 10, because transmitted light 26 transmits through the upper polarizing plate 21b and the lower polarizing plate 21a, the liquid crystal display of the three-dimensional active shutter glasses gives an impression that an original television screen is darker. Further, as the entire light passing through an active area passes through an ITO electrode two times, transmittance of incidence light is lowered. Specifically, the transmittance of incidence light is about 35%. In order to improve such a transmittance decline, a method for forming the ITO electrode in a thin thickness is considered, however when forming an ITO electrode in a thin thickness, a liquid crystal operation characteristic is deteriorated.

### SUMMARY OF THE INVENTION

Aspects of the present invention are to address at least the above mentioned problems and/or disadvantages and to provide at least the advantages described below. Accordingly, an aspect of the present invention is to provide a liquid crystal display for three-dimensional active shutter glasses that enable a user to view a brighter screen by improving a transmittance of incidence light while preventing deterioration of a liquid crystal operation characteristic.

In accordance with an aspect of the present invention, a liquid crystal display for three-dimensional active shutter glasses comprising upper and lower glasses and a liquid crystal layer stacked between the upper and lower glasses is provided. The liquid crystal display comprises an upper Indium Tin Oxide (ITO) electrode formed on a lower surface of the upper glass and formed with a plurality of upper electrode patterns electrically connected to each other, and a lower ITO electrode formed on an upper surface of the lower glass and formed with a plurality of lower electrode patterns electrically connected to each other.

In accordance with another aspect of the present invention, a liquid crystal display for three-dimensional active shutter glasses is provided. The liquid crystal display including upper and lower glasses, a liquid crystal layer stacked between the upper and lower glasses comprising an upper ITO electrode formed on a lower surface of the upper glass and formed with a plurality of upper electrode patterns electrically connected to each other, and a lower ITO electrode formed on an upper surface of the lower glass and formed with a plurality of lower electrode patterns electrically connected to each other, and a lower polarizing plate for linearly polarizing incidence light and an upper polarizing plate comprising a polarizing direction orthogonal to the lower polarizing plate.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view illustrating three-dimensional active shutter glasses and a plan view illustrating a shape of an Indium Tin Oxide (ITO) electrode of a liquid crystal display for the three-dimensional active shutter glasses according to the related art;

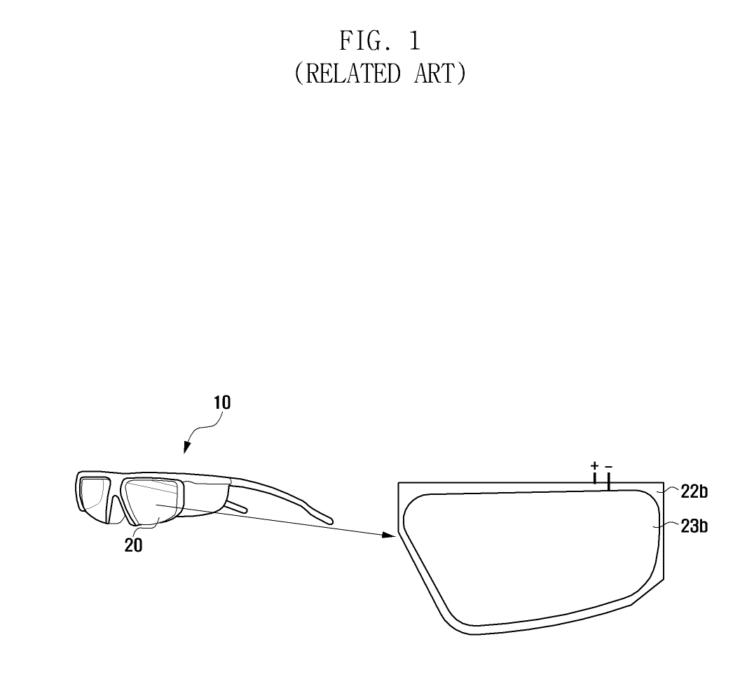

FIG. 2 is a cross-sectional view illustrating a liquid crystal display used for three-dimensional active shutter glasses according to the related art;

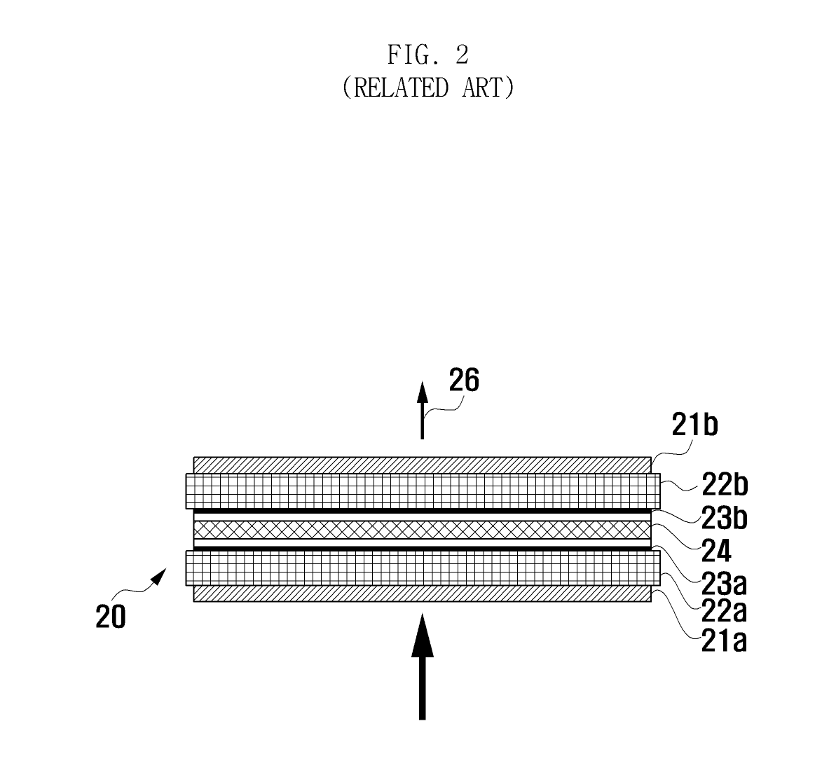

FIG. 3 is a cross-sectional view illustrating a liquid crystal display of three-dimensional active shutter glasses according to an exemplary embodiment of the present invention;

FIG. 4 is a plan view illustrating shapes of an upper ITO electrode and a lower ITO electrode of a liquid crystal display of three-dimensional active shutter glasses according to an exemplary embodiment of the present invention;

FIG. 5 is a partially enlarged view illustrating an upper ITO electrode according to an exemplary embodiment of the present invention;

FIG. 6 is a partially enlarged view illustrating a first modified example of an upper ITO electrode according to an exemplary embodiment of the present invention;

FIG. 7 is a partially enlarged view illustrating a second modified example of an upper ITO electrode according to an exemplary embodiment of the present invention; and

FIG. 8 is a partially enlarged view illustrating a third modified example of an upper ITO electrode according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted to for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

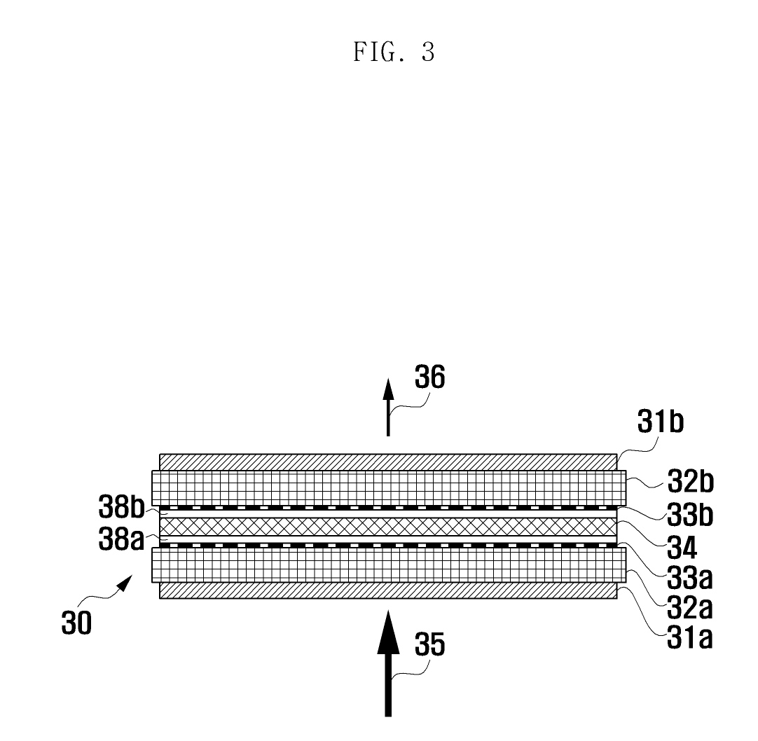

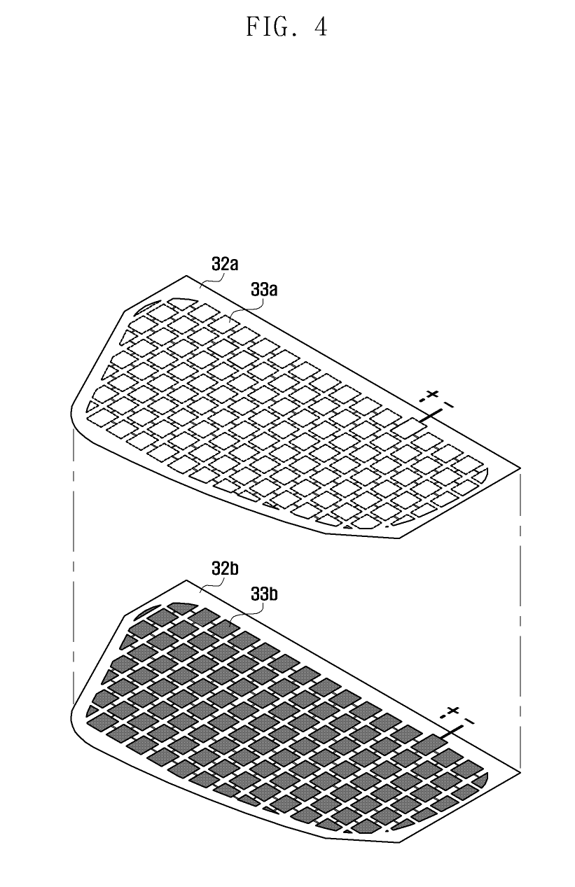

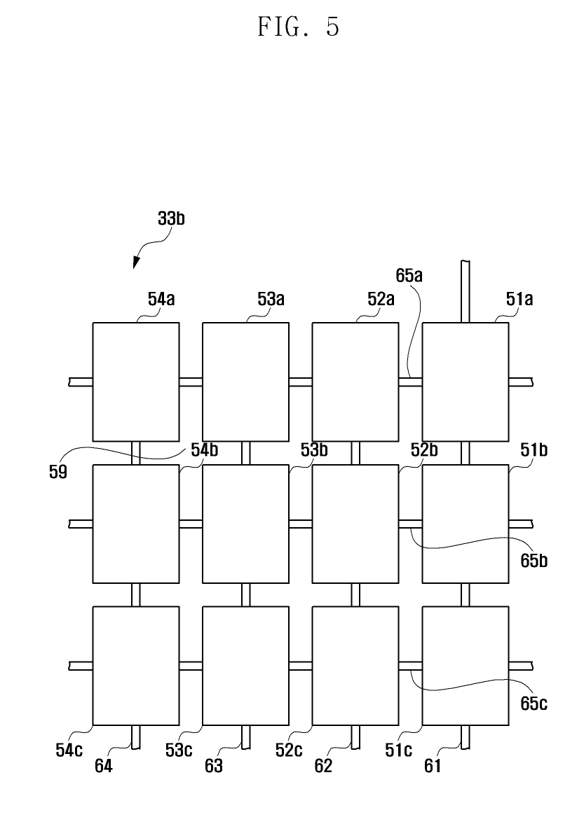

FIG. 3 is a cross-sectional view illustrating a liquid crystal display for three-dimensional active shutter glasses according to an exemplary embodiment of the present invention. FIG. 4 is a plan view illustrating shapes of an upper Indium Tin Oxide (ITO) electrode and a lower ITO electrode of a liquid crystal display for three-dimensional active shutter glasses according to an exemplary embodiment of the present invention. FIG. 5 is a partially enlarged view illustrating an upper ITO electrode according to an exemplary embodiment of the present invention.

Referring to FIGS. 3 to 5, a liquid crystal display 30 for three-dimensional active shutter glasses according to an exemplary embodiment of the present invention is described. The liquid crystal display 30 for the three-dimensional active shutter glasses is a normally white liquid crystal display and includes a lower polarizing plate 31a, a lower glass 32a, a liquid crystal layer 34, an upper glass 32b, an upper polarizing plate 31b, and a pair of ITO electrodes 33a and 33b.

The lower polarizing plate 31a is a linear polarizing plate for linearly polarizing incidence light 35. The upper polarizing plate 3 lb is a linear polarizing plate that is stacked on an upper surface of the upper glass 32b. The upper polarizing plate 31a has a polarizing direction orthogonal to a polarizing direction of the lower polarizing plate 31a because the liquid crystal display 30 for three-dimensional active shutter glasses is a normally white liquid crystal display.

The lower glass 32a is stacked on an upper surface of the lower polarizing plate 31a, and the upper glass 32b is stacked on an upper surface of the liquid crystal layer 34. The lower glass 32a and the upper glass 32b support the liquid crystal layer 34.

The liquid crystal layer 34 is stacked on an upper surface of the lower glass 32a and is formed with Twisted Nematic (TN) type liquid crystal. A lower alignment film 38a and an upper alignment film 38b for aligning liquid crystal molecules in a preset direction are formed on a lower surface and an upper surface of the liquid crystal layer 34, respectively.

A pair of ITO electrodes 33a and 33b perform a function of applying a voltage to the liquid crystal layer 34 and are formed with a lower ITO electrode 33a formed on the upper surface of the lower glass 32a and an upper ITO electrode 33b formed on the lower surface of the upper glass 32b, and the lower ITO electrode 33a and the upper ITO electrode 33b are opposite to each other.

Referring to FIG. 5, the upper ITO electrode 33b is formed with a plurality of upper electrode patterns 51a to 54a, 51b to 54b, and 51c to 54c electrically connected to each other. The upper electrode patterns 51a to 54a arranged in a first row are electrically connected by an upper electrode line 65a arranged in a first row, the upper electrode patterns 51b to 54b arranged in a second row are electrically connected by an upper electrode line 65b arranged in a second row, and the upper electrode patterns 51c to 54c arranged in a third row are electrically connected by an upper electrode line 65c arranged in a third row. Further, the upper electrode patterns 51a to 51c arranged in a first column are electrically connected by an upper electrode line 61 arranged in the first column, the upper electrode patterns 52a to 52c arranged in a second column are electrically connected by an upper electrode line 62 arranged in the second column, the upper electrode patterns 53a to 53c arranged in a third column are electrically connected by an upper electrode line 63 arranged in the third column, and the upper electrode patterns 54a to 54c arranged in a fourth column are electrically connected by an upper electrode line 64 arranged in the fourth column. Referring to FIG. 4, additional upper electrode patterns that are not illustrated in FIG. 5 are connected similarly to the connections illustrated in FIG. 5.

Referring to FIG. 4, the lower ITO electrode 33a is formed with a plurality of lower electrode patterns electrically connected by a lower electrode line with the same method as that of the upper ITO electrode 33b. A plurality of upper electrode patterns are opposite to a plurality of lower electrode patterns, respectively. Liquid crystal molecules in which the upper and lower electrode patterns are formed perform a function as an active shutter by changing a polarized light direction according to whether a voltage is applied to the upper and lower electrode patterns. Further, the opposite upper electrode pattern and lower electrode pattern may have the same shape and the same area, and the upper electrode line and the lower electrode line may be opposite to each other.

In an exemplary implementation, the upper ITO electrode 33b and the lower ITO electrode 33a are opposite to each other, and an ITO non-forming area 59 (illustrated in FIG. 5) is formed between the electrode patterns and thus the liquid crystal display for the three-dimensional active shutter glasses has an improved transmittance of incidence light.

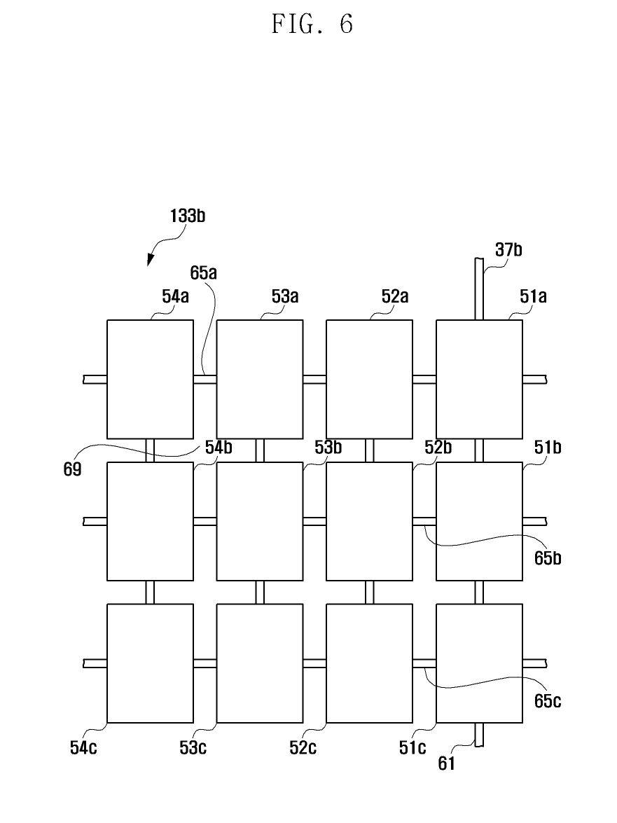

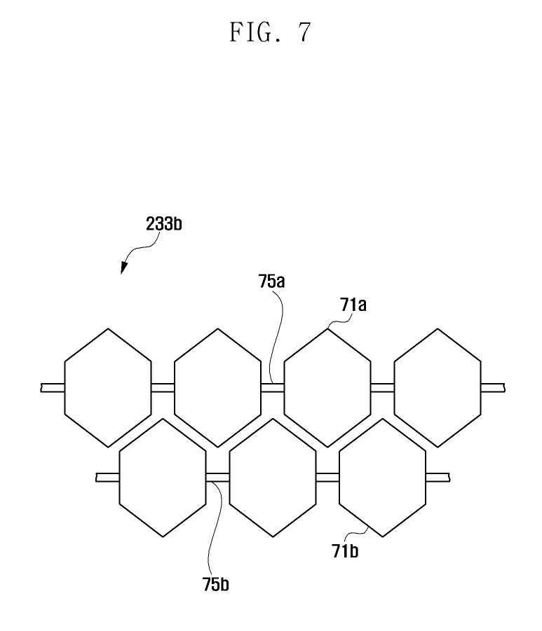

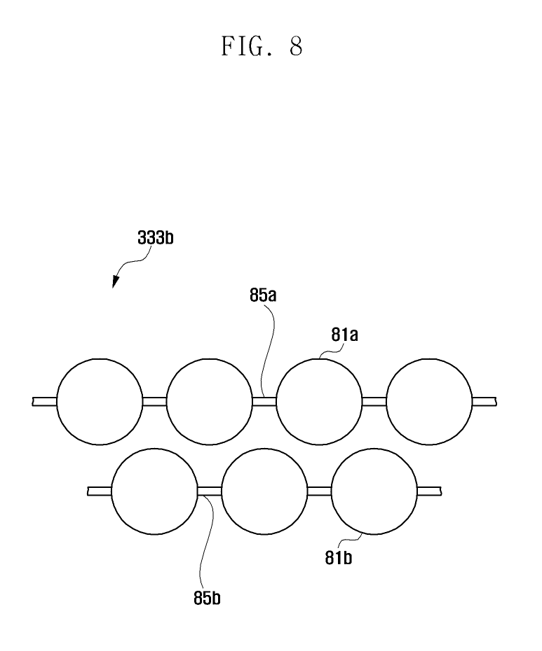

FIG. 6 is a partially enlarged view illustrating a first modified example of an upper ITO electrode according to an exemplary embodiment of the present invention. FIG. 7 is a partially enlarged view illustrating a second modified example of an upper ITO electrode according to an exemplary embodiment of the present invention. FIG. 8 is a partially enlarged view illustrating a third modified example of an upper ITO electrode according to an exemplary embodiment of the present invention.

Referring to FIG. 6, in an upper ITO electrode 133b, only upper electrode patterns 51a to 51c arranged in a first column are connected by an upper electrode line 61 arranged in the first column, and upper electrode patterns arranged in the remaining columns are not connected by an electrode line. Since upper electrode patterns 51a to 54a, 51b to 54b, and 51c to 54c arranged in each column are connected by upper electrode lines 65a, 65b, and 65c arranged in each row, all upper electrode patterns forming the upper ITO electrode 133b are electrically connected. When compared with the upper ITO electrode 33b illustrated in FIG. 5, an area of an ITO non-forming area 69 of the first modified example is greater than that of the ITO non-forming area 59 illustrated in FIG. 5. Therefore, a transmittance of incidence light in the first modified example is greater than the incidence light illustrated in FIG. 5.

Referring to FIG. 7, in an upper ITO electrode 233b according to a second modified example, each upper electrode pattern 71a and 71b is formed in a hexagonal shape. Further, the upper electrode patterns 71a and 71b arranged in each row are electrically connected by upper electrode patterns 75a and 75b arranged in each row. Further, upper electrode patterns arranged in different rows are electrically connected by an upper electrode line that is not illustrated in FIG. 7.

Referring to FIG. 8, in an upper ITO electrode 333b according to a third modified example, upper electrode patterns 81a and 81b are each formed in a circular shape. Further, the upper electrode patterns 81a and 81b arranged in each row are electrically connected by upper electrode lines 85a and 85b arranged in each row. Further, upper electrode patterns arranged in different rows are electrically connected by an upper electrode line that is not illustrated in FIG. 8.

As described above, according to the exemplary embodiments of the present invention, by forming an ITO electrode as a plurality of electrode patterns in the liquid crystal display for three-dimensional active shutter glasses, a liquid crystal operation characteristic is prevented from being deteriorated and transmittance of incidence light is improved. Thus, a user can view a brighter screen.

While the invention has been shown and described with reference to certain exemplary embodiments thereof, it will be understood by those skilled in the art that various changes may be made therein without departing from the spirit and scope of the exemplary embodiments of the present invention as defined in the appended claims.

What is claimed is:

1. A liquid crystal display for three-dimensional active shutter glasses including upper and lower glasses and a liquid crystal layer stacked between the upper and lower glasses, the liquid crystal display comprising:
an upper Indium Tin Oxide (ITO) electrode formed on a lower surface of the upper glass and formed with a plurality of upper electrode patterns electrically connected to each other; and
a lower ITO electrode formed on an upper surface of the lower glass and formed with a plurality of lower electrode patterns electrically connected to each other.

2. The liquid crystal display of claim 1, wherein the liquid crystal display comprises a normally white liquid crystal display.

3. The liquid crystal display of claim 1, wherein each of the plurality of upper electrode patterns is opposite to each of the plurality of lower electrode patterns, respectively.

4. The liquid crystal display of claim 1, wherein each of the plurality of upper electrode patterns is electrically connected by an upper electrode line, and each of the plurality of lower electrode patterns is electrically connected by a lower electrode line.

5. The liquid crystal display of claim 3, wherein the plurality of upper electrode patterns and the plurality of lower electrode patterns comprise the same shape and area.

6. The liquid crystal display of claim 4, wherein the upper electrode line and the lower electrode line are opposite to each other.

7. The liquid crystal display of claim 4, wherein the upper electrode line is formed between adjacent upper electrode patterns, and
the lower electrode line is formed between adjacent lower electrode patterns.

8. The liquid crystal display of claim 1, further comprising a lower polarizing plate for linearly polarizing incident light and an upper polarizing plate comprising a polarizing direction orthogonal to a polarizing direction of the lower polarizing plate.

9. The liquid crystal display of claim 1, wherein the upper ITO electrode and the lower ITO electrode apply a voltage to the liquid crystal layer.

10. The liquid crystal display of claim 1, wherein the upper and lower electrode patterns are formed with liquid crystal molecules that change a polarized light direction according to whether a voltage is applied to the upper and lower electrode patterns.

11. A liquid crystal display for three-dimensional active shutter glasses, the liquid crystal display comprising:
upper and lower glasses;
a liquid crystal layer stacked between the upper and lower glasses comprising an upper Indium Tin Oxide (ITO) electrode formed on a lower surface of the upper glass and formed with a plurality of upper electrode patterns electrically connected to each other, and a lower ITO electrode formed on an upper surface of the lower glass and formed with a plurality of lower electrode patterns electrically connected to each other; and
a lower polarizing plate for linearly polarizing incident light and an upper polarizing plate comprising a polarizing direction orthogonal to a polarizing direction of the lower polarizing plate.

12. The liquid crystal display of claim 11, wherein the liquid crystal display comprises a normally white liquid crystal display.

13. The liquid crystal display of claim 11, wherein each of the plurality of upper electrode patterns is opposite to each of the plurality of lower electrode patterns, respectively.

14. The liquid crystal display of claim 13, wherein the plurality of upper electrode patterns and the plurality of lower electrode patterns comprise the same shape and area.

15. The liquid crystal display of claim 1, wherein each of the plurality of upper electrode patterns is electrically connected by an upper electrode line, and
each of the plurality of lower electrode patterns is electrically connected by a lower electrode line.

16. The liquid crystal display of claim 15, wherein the upper electrode line and the lower electrode line are opposite to each other.

17. The liquid crystal display of claim 16, wherein the upper electrode line is formed between adjacent upper electrode patterns, and
the lower electrode line is formed between adjacent lower electrode patterns.

18. The liquid crystal display of claim 1, wherein the upper ITO electrode and the lower ITO electrode apply a voltage to the liquid crystal layer.

19. The liquid crystal display of claim 18, wherein the upper and lower electrode patterns are formed with liquid crystal molecules that change a polarized light direction according to whether the voltage is applied to the upper and lower electrode patterns.
